(19) United States
(12) Patent Application Publication
(10) Pub. No.: US 2004/0168360 A1
(43) Pub. Date: Sep. 2, 2004

(54) Cling mounting corners

(76) Inventor: Laurie Joel Lupke, Clearwater, FL (US)

Correspondence Address: Laurie J. Lupke, 2438 Enterprise Road #2612, Clearwater, FL, 33763, US

(21) Appl. No.: 10/623,966

(22) Filed: Jul. 21, 2003

Related U.S. Application Data
(60) Provisional application No. 60/397,673, filed on Jul. 22, 2002.

(51) Int. Cl. G09F 7/12

(52) U.S. Cl. 40/594; 40/752

(57) ABSTRACT

A non adhesive, removable, reusable mounting method for inexpensively, simply and readily mounting, dismounting and remounting planar display articles upon a rigid, smooth, glossy backing surfaces, said surface having both greater length and width than the article or articles to be mounted, allowing for spacing between articles, comprising a set of four mounting corners cut from a flexible cling material upon a single carrier sheet, said sheet, which when bent in half will release the said corners with ease, said corners to be placed correspondingly (right angle to right angle) at each corner of the display article, the hypotenuse of each mounting corner overlapping and extending beyond the corner of the display article clinging to the backing surface at the area of extension, thereby bracing said article at the area of overlap.

### CROSS REFERENCE TO RELATED APPLICATIONS

Provisional Application for Patent filed Jul. 22, 2002, Confirmation Number 1891, Application No. 60/397,673.

### STATEMENT REGUARDING FEDERALLY SPONSORED RESEARCH OR DEVELOPMENT

Not applicable.

### REFERENCE TO SEQUENCE LISTING, ETC

Not applicable.

### BACKGROUND OF THE INVENTION

It has become increasingly common for computer printed paper signs to be displayed in windows and entry doors of commercial buildings such as stores, office buildings, restaurants, banks, etc. Typically, the signs convey to the public, customers, employees, etc. which entrance to use, holiday hours, sales, specials, and numerous other informational and pictorial displays intended to advertise, educate, guide, humor, etc.

Essentially, the personal computer has created a revolution in sign making for small scale advertising. In the past for information to be presented in an attractive manner it had to be created by someone with artistic skill or with stencils which also require skill, or a changeable letter or ready made sign could be used. Otherwise, signs had to be professionally printed by a sign shop or commercial print shop. Now, however, with the personal computer, businesses and organizations are able to convey information readily and attractively with a wide variety of font styles and sizes, borders, and other options available using their own printers.

Almost always these signs are mounted with adhesive tape which leaves a sticky residue, the removal of which requires time and effort. Sometimes a special tool (the razor scraper) or special cleaners (gum removers) are sought, thereby adding to the expense of the this supposedly cheap mounting method. Additionally, the paper will often sag and gap do to poor placement of the tape, sometimes resulting in tearing. Also, the look of the tape does nothing to enhance the display.

Further, the signs seem to be placed upon a surface according to two criteria: Number one, the mounting surface must be in a convenient, conspicuous location and number two, adhesive tape will stick there. If the first criteria is met but the location lacks the second criteria a common adaptation is to mount a bulletin board usually made of cork or foam, necessitating the use of some piercing object such as a push pin, tack, or staple, usually resulting in the impaling of the article. Again, this system often features articles with sags, gaps, and tears.

Obviously, site advertising is only one of numerous communication fields that has undergone a significant change due to the capabilities afforded by the personal computer and printer. It is anticipated that an improvement in simple, inexpensive means of readily mounting, dismounting, and remounting various types of computer generated works as well as other planar articles for essentially temporary display would be of general benefit to all.

The simplicity and effectiveness of the system and method employed in the present invention is due to a property commonly known as static cling. However, as pointed out by inventor William C. Peck in Pat. No. 5,899,010 entitled STATIC CLING BANNER, “No implication is here made as to whether the force that causes static cling is only an attractive force due to static electricity.” And, “Other forces, in fact, . . . may contribute . . . to the . . . adhesion.”

Peck also points out the need for “clear, well-constructed sign systems which can be managed by individuals with limited artistic skills,” as well as “a need for reusable sign . . . systems.” He further points to the inefficacy of so called removable adhesives for repeated use, such as may be desired if the display article is a laminated sign for use on certain occasions, holidays, etc. or for holiday decorations in general.

The original idea pertaining to this invention was to use a single sheet of transparent static cling material (plasticized polyvinyl chloride) having a greater length and width than the sign to be displayed, to paint a border on the peripheral dimensions of the material which were in excess of the dimensions of the sign, leaving a transparent region in the center for viewing the sign, and then to capture the sign between the sheet of cling material and the exterior window surface of a building. Upon initial research, however, it was found that Pat. No. 5,916,650 entitled REMOVABLE DISPLAY COVER AND METHOD has taught this idea already.

Fortunately, the system and method of the present invention, CLING MOUNTING CORNERS, will achieve the original goal of providing an improved method for displaying essentially temporary computer generated signs as well as enhancing the border of said signs and, to the benefit of all, uses significantly less material than the REMOVABLE DISPLAY COVER AND METHOD, is there for much cheaper, and allows for easy accommodation of a wide variety of sizes and shapes using a single embodiment. Also, the present method avoids the glare that could occur on the article by completely covering it with the glossy material. If an unsheltered outdoor environment is chosen as the mounting location the sign can be laminated to protect it.

Another inventor having a goal very similar to my own is published in Pat. No. 5,974,715 entitled, ARTICLE FOR FRAMING A VISUAL WORK. The present invention achieves the goal using a substantially simpler method and is weather durable.

A recent Pat. No. 6,401,376, incorporates the use of adhesives in constructing the framing device entitled, FRAME TYPE PHOTOGRAPH MOUNTING ASSEMBLY. The present invention specifically excludes the use of adhesives.

### BRIEF SUMMARY OF THE INVENTION

The CLING MOUINTING CORNERS overcome the problem of sticky residue which accompanies the adhesive tape mounting method without sacrificing the simplicity, low cost, convenience, and holding power adhesive tape provides. The present mounting method is completely removable making the tasks of hanging, taking down, and changing signs or other display articles quick and easy. The type of backing required in the CLING MOUNTING CORNERS can be significantly cheaper than cork or foam style backings yet does not require the piercing of the display item, while at the same time retains the advantage of the tacks and push pins: reusability. CLING MOUNTING CORNERS will hold the display article to the surface flatter and more securely than tape, tacks, push pins or staples, is removable, reusable, and leaves the display article intact with no adhesive residue or punctures. CLING MOUNTING CORNERS also provide an optional means for enhancing the border region surrounding the display item using non transparent embodiments of the removable, reusable static cling material.

CLING MOUNTING CORNERS uses a system for mounting planar display articles comprising the following three components: First, a rigid, smooth, glossy backing surface which measures greater in both length and width than the article or articles to be mounted, allowing for spacing between articles. This backing may be a laminated sheet of paper, a sheet of glass, the window of a building, a mirrored wall, or any glass or glass like surface. Second, a non adhesive means for fastening the article upon the backing surface comprising a plurality of removable, reusable, mounting pieces cut from a flexible static cling material to be placed overlapping and extending beyond the periphery of the article, clinging to display surface at area of extension, thereby bracing the article at area of overlap.

Third, the preferred embodiment for the CLING MOUNTING CORNERS is a six inch by six inch square backing sheet upon which the cling material has been kiss cut (the cling material is cut but not the backing sheet) diagonally from corner to corner creating a set of four CLING MOUNTING CORNERS the desired number, shape, and size to mount a standard sized (8 and ½ by 11 inches) sheet of paper.

The object of this invention is to replace adhesive tape in mounting paper display articles on glass or glass like surfaces. The invention could lead to the replacement of cork and foam style backings with glossy surface style backings.

### BRIEF DESCRIPTION OF THE SEVERAL VIEWS OF THE DRAWING

FIG. 1 illustrates the placement of one of the four CLING MOUNTING CORNERS

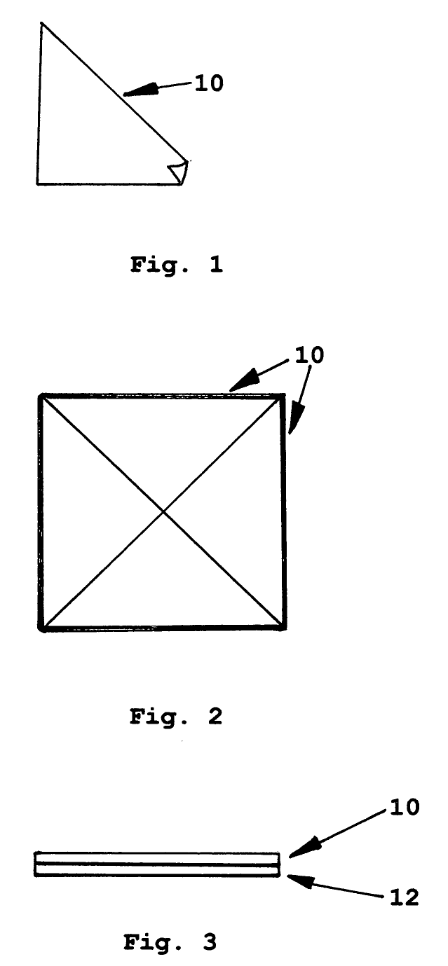

FIG. 2 shows a typical venue for the use of the invention

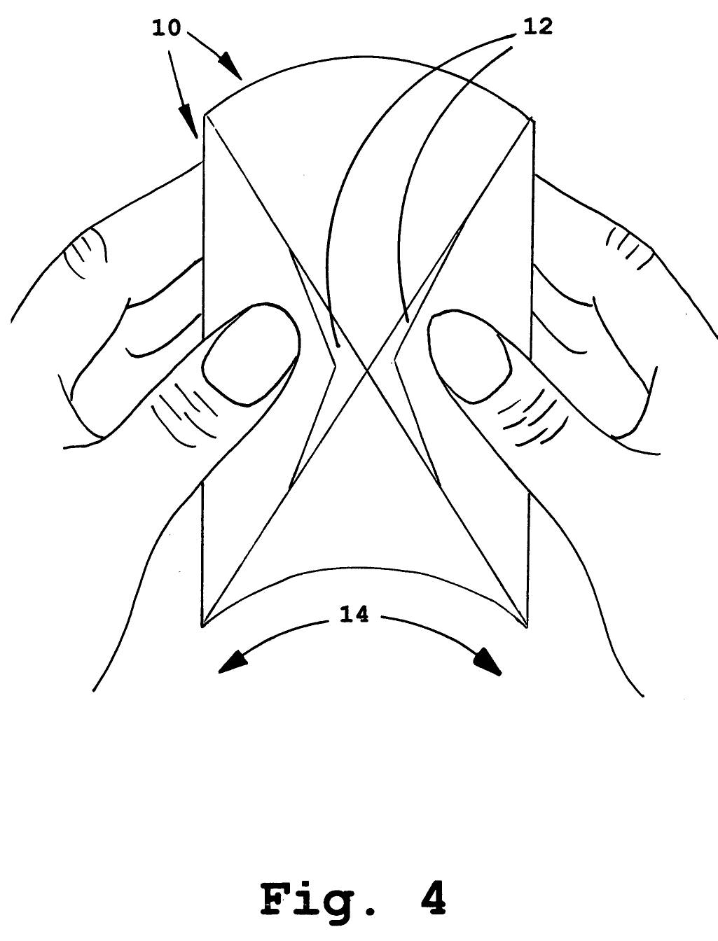

FIG. 3 depicts the preferred embodiment for the CLING MOUNTING CORNERS on a six inch square backing sheet with the cling material kiss cut diagonally from corner to corner which will allow the backing sheet when bent in half to release the CLING MOUNTING CORNERS from the center of said backing.

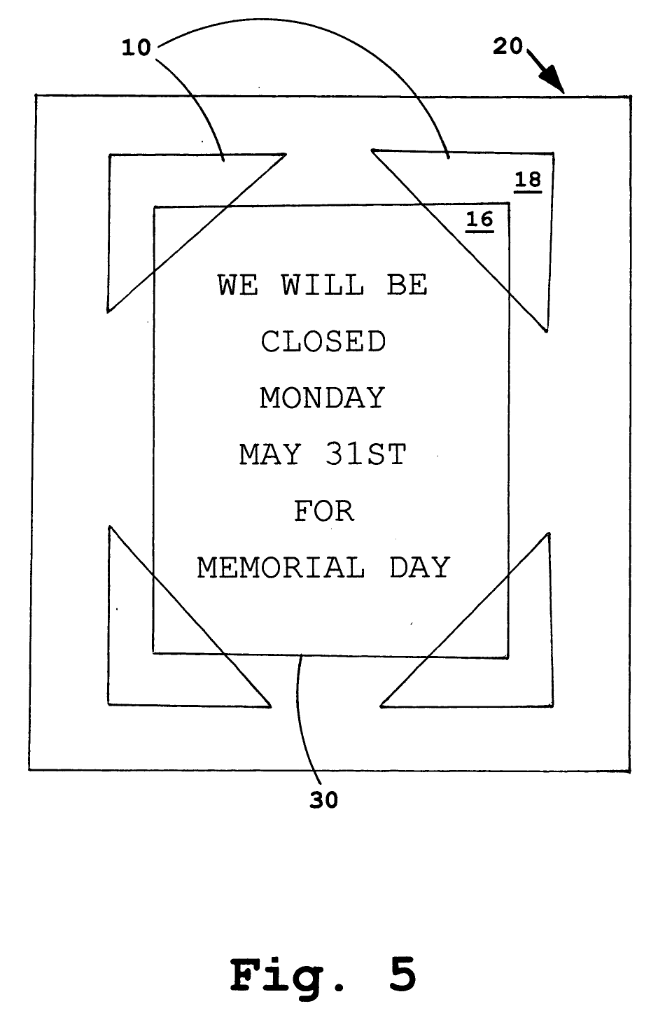

### DETAILED DESCRIPTION OF THE INVENTION

The system is so simple anyone can make it and use it. A cling material can be bought in the fabric department at the local national discount chain for about a dollar or a dollar and a half a yard. It is called Vinyl Covering: Double Polished Clear Vinyl by Kittrich Corporation. One yard is sufficient. The material is known in the art of sign making as plasticized polyvinyl chloride. It is most often seen upon a carrier sheet which aids in its handling, as the material is very flaccid.

First, a backing is required. The backing surface may be an existing part of a building, such as a window, glass door, or mirrored wall; or may be any rigid, smooth, high gloss surface. Alternatively, to make a backing, any rigid board can be painted or covered with a fabric before being covered with the transparent vinyl material.

To make the preferred embodiment of the mounting pieces for use with standard sized paper, simply cut a six inch by six inch square from the cling material, then cut the square diagonally from corner to corner, into four right triangles.

The mounting method resembles the method employed in scrap books to secure the corners of photographs and memorabilia.* (Please see note at end) Each mounting corner must be placed correspondingly (right angle to right angle) at each corner of the display article, extending approximately a half inch beyond periphery of said article, contacting and thereby clinging to the display surface. The hypotenuse of the mounting corner will lay diagonally across the corner of the display article to function as a brace. To best secure the edges of the mounting corner which extend beyond the article to contact and cling to the display surface simply press down to achieve maximum contact. Using a cloth or tissue will help to speed movement as pressure is being applied. Thus the article is securely fastened to the surface. The bond will last for an extended period of time including one or more years. *As a side note, CLING MOUNTING CORNERS are not recommended for use with glossy photographic paper, as the chemicals on the paper will bond with the vinyl and mar both the mounting piece and the photograph. The vinyl material works well with regular paper, as is commonly used now with computer printed digital photography.

To remove each CLING MOUNTING CORNER simply lift embodiment from its hypotenuse at area where embodiment overlaps the paper. Here the cling effect will not be present and embodiment may be quickly and easily removed. The pieces should be stored in a cool dry place, as increased temperature and humidity will cause the material to lose integrity.

In the year since I filed the Provisional Application for Patent I have found two similar products on the internet. One is called FLEXIFRAME, a promotional item which can be printed with a message designed to capture either a three inch by five inch or five by seven inch picture. What sets my product apart from FLEXIFRAME is that CLING MOUNTING CORNERS will hold a standard size sheet of paper and can be cut in half to accommodate smaller sizes. My invention consists of four pieces being placed at the corners, not a unistructural frame. The other product is called MAGIC MOUNTS. It is available from STIC-EES, a provider of window cling decorations. Their product is designed to hold school pictures with various sport and decorative motifs. The different shapes can be placed in the method described above. However, the present invention holds larger sized display articles such as standard sheets of paper much more securely and is much more suited to the object as described: to affix storefront computer printed signs. CLING MOUNTING CORNERS are specifically designed to hold full sheets of paper securely in high traffic areas. These others are not suited for this task.

In the preferred method of making the CLING MOUNTING CORNERS for commercial sale the material would be machine printed (optional) and cut. The process is well known in the art and there are hundreds, if not thousands, of sign shops that could produce this invention, if permitted. By using a machine cutting process the product could be sold in convenient ready to use embodiment for about the cost of buying a yard of the material and cutting the pieces oneself. Of course, there will be fewer pieces in the retail embodiment. However, because the invention is reusable a yards worth of mounting corners would probably not be an appropriate quantity for most consumers.

For high speed manufacturing the material must be purchased upon a stiff carrier sheet. Although using a carrier sheet increases the cost substantially, the cost is off set by the ease of handling afforded by the addition of the carrier sheet which allows the material to be transported through high speed machinery without collapsing and without sticking to itself. Also, when not in use the pieces can be stored upon their carrier sheet. A die cutter will cut the squares for the mounting corners through the layer of cling material and through the carrier sheet. The diagonal cuts, however, will be gauged to only cut the cling material and not the carrier sheet. This embodiment will allow the carrier sheet to, when bent in half, release the edges of the cling material. This solves the problem of trying to separate the cling material from the carrier sheet as might be the case if the pieces were cut to a single embodiment. Also, it is important for the sake of convenience that each single carrier sheet contains one full set of the exact embodiment needed to mount a single article.

The corner pieces can also be cut in half from the center of the hypotenuse to the angle of the perpendicular to accommodate smaller display items such as post cards, etc.

I claim as my invention:

1. A set of four mounting corners cut from a flexible cling material upon a single carrier sheet, said sheet, which when bent in half will release said mounting corners with ease.
